(19) United States
(12) Patent Application Publication
(10) Pub. No.: US 2014/0063287 A1
(43) Pub. Date: Mar. 6, 2014

(54) IMAGING APPARATUS

(71) Applicant: Manabu YAMADA, Yokohama-shi (JP)

(72) Inventor: Manabu YAMADA, Yokohama-shi (JP)

(21) Appl. No.: 13/974,267

(22) Filed: Aug. 23, 2013

(30) Foreign Application Priority Data
Aug. 28, 2012 (JP) 2012-187127

(51) Int. Cl. H04N 5/235

(52) U.S. Cl. CPC H04N 5/2351
USPC 348/229.1

(57) ABSTRACT

An imaging apparatus including an image sensor that images an image of a photographic subject; a flash that emits light to the photographic subject; and a controller that controls the flash to emit light, in a case where a light amount of the image of the photographic subject in an imaged image formed on the image sensor is underexposed, wherein the controller includes a dividing and amplifying function part that divides the imaged image into a plurality of grid-like block, and applies digital gain per each divided block; and a flash emission influence degree determination function part that determines a flash influence degree per each divided block, and in a case of emitting the flash and performing shooting, the controller determines a value of the digital gain applied per each divided block by the dividing and amplifying function part, in accordance with the flash influence degree per each divided block.

### CROSS-REFERENCE TO RELATED APPLICATIONS

The present application is based on and claims priority from Japanese Patent Application Number 2012-187127, filed Aug. 28, 2012, the disclosure of which is hereby incorporated by reference herein in its entirety.

### BACKGROUND

The present invention relates to an imaging apparatus, in particular, to an imaging apparatus having a flash light-adjusting control function.

Conventionally, when shooting is performed with an imaging apparatus such as a camera, or the like with only natural light, and lack of exposure occurs with respect to a main photographic subject, flash shooting in which supplemental light is emitted to supplement an exposure amount is often performed.

However, an influence of light emission by a flash is large at a close range, and is small at a distant range. And therefore, for example, even when a main photographic subject is in an appropriate brightness state, background is dark, and in a case where there are a plurality of main photographic subjects desired to be photographed and each distance between each of the main photographic subjects and the flash is different, only one of the photographic subjects is in a state of appropriate brightness, and the rest of the photographic subjects are not in the state of the appropriate brightness.

In order to solve such a problem, an imaging apparatus is known to supplement an amount of light such that a difference in distance from the imaging apparatus among a plurality of photographic subjects which are desired to be photographed is calculated, and gain is applied to increase flash light when the difference is small, and to reduce the flash light when the difference is large (see Japanese Patent Application Publication No. 2011-095403, for example). In a case where a plurality of photographic subjects are photographed with this imaging apparatus, as a difference in distance from the imaging apparatus among the photographic subjects becomes larger, a degree of influence of flash (flash influence degree) becomes different per photographic subject when emitting the flash light, and a difference in brightness tends to occur. Accordingly, a method of obtaining an image having appropriate brightness has been proposed such that larger gain is applied evenly to an image, in which when the difference in distance from the imaging apparatus among the photographic subjects is small, the flash light is increased, and when the difference in distance from the imaging apparatus among the photographic subjects is large, the flash light is reduced.

However, with a conventional imaging apparatus, the flash light has to be reduced when the difference in distance from the imaging apparatus among the photographic subjects is large, and gain is high overall. Accordingly, an image tends to be an image having strong noise overall, and it is difficult to adjust brightness appropriately, in a case where a plurality of photographic subjects at different distances from the flash are photographed with the flash light.

### SUMMARY

Accordingly, an object of the present invention is to provide an imaging apparatus that adjusts brightness appropriately even in a case where a plurality of photographic subjects at different distances from a flash are photographed.

In order to achieve the above object, an embodiment of the present invention provides: an imaging apparatus comprising an image sensor that images an image of a photographic subject; a flash that emits light to the photographic subject; and a controller that controls the flash to emit light to the photographic subject, in a case where the image of the photographic subject in an imaged image formed on the image sensor is underexposed, wherein the controller includes a dividing and amplifying function part that divides the imaged image into a plurality of grid-like blocks, and applies digital gain per each divided block; and a flash emission influence degree determination function part that determines a flash influence degree per each divided block, and in a case of emitting the flash and performing shooting, the controller determines a value of the digital gain applied per each divided block by the dividing and amplifying function part, in accordance with the flash influence degree per each divided block determined by the flash emission influence degree function part.

### BRIEF DESCRIPTION OF THE DRAWINGS

FIGS. 1A, 1B, and 1C illustrate a front view, a top view, and a rear view of a digital camera as an example of an imaging apparatus according to an embodiment of the present invention, respectively.

FIG. 2 is a block diagram illustrating a schematic system configuration in the digital camera illustrated in FIGS. 1A, 1B, and 1C.

FIG. 3 is a more detailed block diagram of a system controller illustrated in FIG. 2.

FIG. 4A illustrates an imaged image in which a plurality of photographic subjects at different distances from the digital camera are in a state of appropriate brightness. FIG. 4B is an explanatory diagram of the imaged image when the plurality of photographic subjects in FIG. 4A are photographed with flash.

FIG. 5A illustrates an imaged image in which a plurality of photographic subjects at different distances from the digital camera are in a state of appropriate brightness. FIG. 5B is an explanatory diagram illustrating an example where the imaged image in FIG. 5A is divided into grid-like blocks, and a gain value is set to each block.

FIG. 6 is an explanatory diagram of gain calculation in a plurality of the blocks illustrated in FIG. 5B.

FIG. 7 is an explanatory diagram illustrating a relationship between a degree of influence of flash (flash influence degree) and gain.

FIG. 8 is a gain characteristic diagram illustrating a relationship between a distance from flash and gain.

FIG. 9 is a flow diagram explaining a gain setting based on determination of a flash influence degree, and the flash influence degree.

FIG. 10 is an external diagram of a digital camera, on a front side of which a supplemental imaging optical system having one lens exclusive for distance measurement is provided.

FIG. 11 is an external diagram of a rear side of the digital camera illustrated in FIG. 10.

FIG. 12 is an explanatory diagram illustrating a schematic internal configuration of the digital camera illustrated in FIG. 10.

FIG. 13 is an explanatory diagram of an optical system in a case where an imaging lens as a main optical system illustrated in FIG. 12 is also used as an AF lens.

FIG. 14 is an explanatory diagram of distance measurement by using the imaging lens as the main optical system and the AF lens illustrated in FIG. 13.

FIG. 15 is an explanatory diagram in a case where an output signal of a CMOS sensor illustrated in FIG. 13 and an output signal of a light-receiving sensor that receives light flux from an AF lens are used for distance measurement.

FIG. 16 is an external diagram of a front side of a digital camera 1 having two AF lenses as a supplemental imaging optical system for distance measurement.

FIG. 17 is an explanatory diagram illustrating a schematic internal configuration of the digital camera illustrated in FIG. 16.

FIG. 18 is an explanatory diagram of distance measurement performed by the supplemental imaging optical system illustrated in FIGS. 16 and 17.

FIG. 19 is a flow diagram explaining a gain setting based on determination of a distance to a photographic subject and a flash influence degree, and the flash influence degree.

### DETAILED DESCRIPTION OF THE PREFERRED EMBODIMENTS

Hereinafter, an embodiment of the present invention will be explained with reference to the drawings.

### Example 1

### Structure

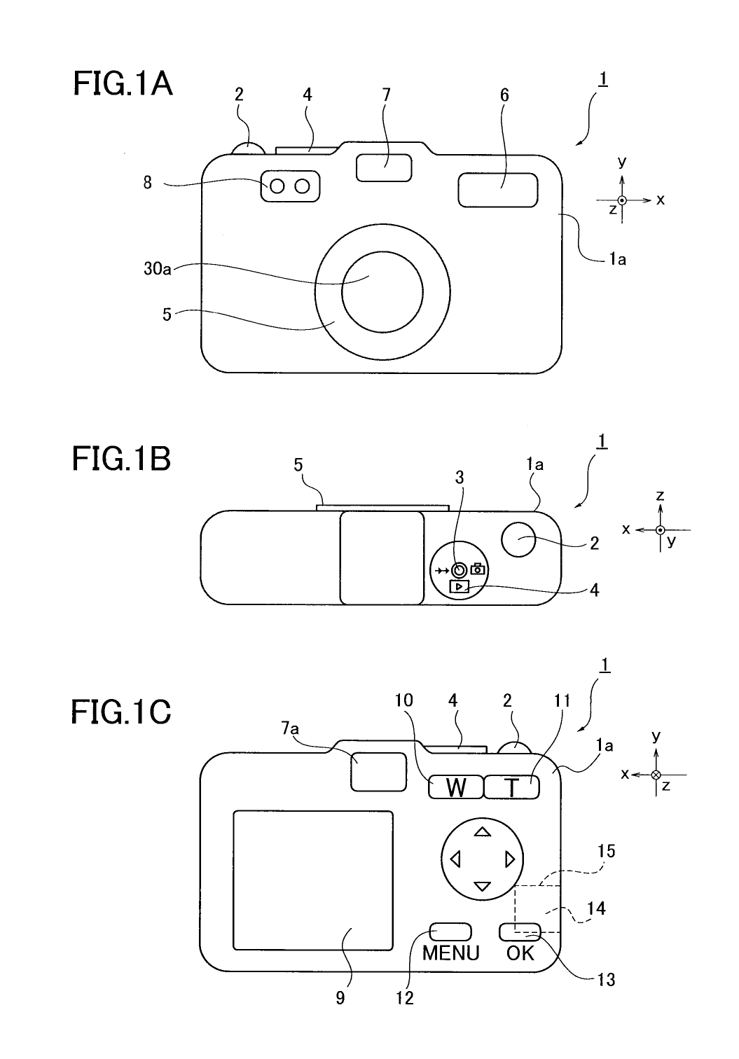

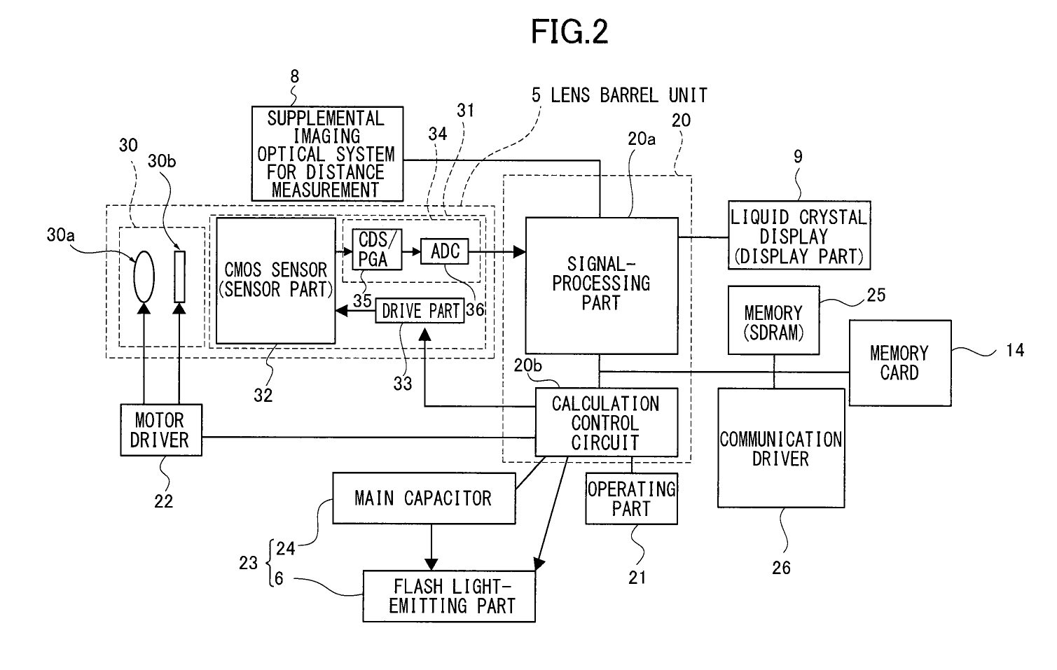

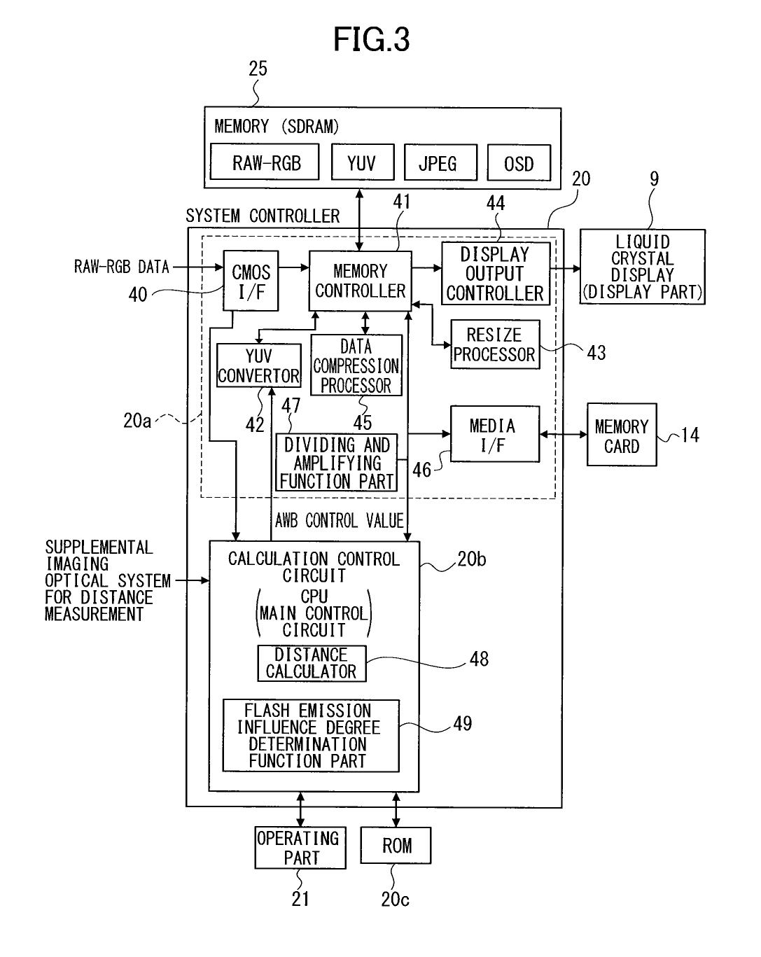

FIG. 1A is a front view of a digital camera as an example of an imaging apparatus according to an embodiment of the present invention. FIG. 1B is a top view of the digital camera illustrated in FIG. 1A. FIG. 1C is a rear view of the digital camera illustrated in FIG. 1A. FIG. 2 is a schematic block diagram of a control circuit (system configuration) in the digital camera illustrated in FIGS. 1A, 1B, and 1C.

### [External Structure of Digital Camera]

As illustrated in FIGS. 1A, 1B, and 1C, a digital camera 1 according to an embodiment of the present invention has a camera body 1a. As illustrated in FIG. 1B, on a top side of the camera body 1a, a shutter release button (shutter button) 2, a power button (power switch) 3, and a shooting/playback switch dial 4 are provided.

Additionally, as illustrated in FIG. 1A, on a front side of the camera body 1a, a lens barrel unit 5 as an imaging lens unit, a flash light-emitting part (flash) 6, an optical viewfinder 7, and a supplemental imaging optical system for distance measurement 8 are provided.

Furthermore, as illustrated in FIG. 1C, on a rear side of the camera body 1a, a liquid crystal display (display part) 9, an eyepiece lens part 7a of the optical viewfinder 7, a wide-angle zoom (W) switch 10, a telephoto zoom (T) switch 11, a menu (MENU) button 12, a confirmation button (OK button) 13, and the like are provided.

Additionally, inside a side surface of the camera body 1a, as illustrated in FIG. 1C, a memory card slot 15 in which a memory card 14, which stores imaged image data, is placed is provided.

### [Imaging System of Digital Camera 1]

FIG. 2 illustrates an imaging system of the digital camera 1. The imaging system has a system controller (system control circuit) 20 as a controller. A digital signal-processing IC, or the like is used in the system controller 20.

The system controller 20 has a signal-processing part 20a and a calculation control circuit (CPU, that is, main controller) 20b. The signal-processing part 20a is an image-processing circuit (image-processing part) that processes a digital color image signal (digital RGB image signal). The calculation control circuit 20b performs control of the signal-processing part 20a and each part. To the signal-processing part 20a, a distance-measuring signal from the supplemental imaging optical system 8 is inputted, and to the calculation control circuit 20b, an operation signal from an operating part 21.

The operating part 21 includes the above-described shutter release button (shutter button) 2, power button 3, shooting/playback switch dial 4, wide-angle zoom (W) switch 10, telephoto zoom (T) switch 11, menu (MENU) button 12, confirmation button (OK button) 13, and the like, which is related to an imaging operation, and operable by a user.

Additionally, the imaging system has the LCD (display part) 9, the memory card 14, an optical system-driving part (motor driver) 22, and flash 23. The flash 23 has the flash light-emitting part 6 illustrated in FIG. 1A, and a main capacitor 24. The main capacitor 24 supplies a voltage for emitting light to the flash light-emitting part 6. Furthermore, the imaging system has a memory (SDRAM) 25 that temporarily stores data, a communication driver (communication part) 26, and the like.

In addition, the imaging system has the lens barrel unit 5 that is controlled and driven by the system controller 20.

### [Lens Barrel Unit 5]

The lens barrel unit 5 has a main imaging optical system 30, and an imaging part 31. The imaging part 31 images an image of a photographic subject from incident light via the main imaging optical system 30.

The main imaging optical system 30 has an imaging lens (shooting lens) 30a that has a zoom optical system (not illustrated in detail), and an incident light flux controller 30b.

The imaging lens 30a has a zoom lens (not illustrated), and a focus lens (not illustrated). Zoom driving of the zoom lens is performed by an operation of the wide-angle zoom (W) switch 10, the telephoto zoom (T) switch 11, or the like of the operating part 21, when zooming. Focus driving of the focus lens is performed by a half-press operation of the shutter release button 2, when focusing. Positions of those lenses are changed mechanically and optically, when zooming, when focusing, and when starting/stopping operation of the camera by an ON/OFF operation of the power button 3. When starting the operation of the camera by the ON operation of the power button 3, the imaging lens 30a moves forward to an initial position of the beginning of imaging, and when stopping the operation of the camera by the OFF operation of the power button 3, the imaging lens 30a moves backward to a storage position where the imaging lens is stored. Since known structures are adopted in those structures, detailed explanations are omitted.

Zoom driving, focus driving, and drive control when starting/stopping operation of an imaging lens 30 are performed by an optical system drive part (motor driver) 22, the operation control of which is performed by the calculation control circuit 20b as a main control part (CPU, that is, main controller). Operation control of the optical system drive part (motor driver) 22 by the calculation control circuit 20b is performed based on an operation signal from the wide-angle zoom (W) switch 10, the telephoto zoom (T) switch 11, the power button 3, or the like of the operating part 21.

The incident light flux controller 30b has an aperture unit and a mechanical shutter unit (not illustrated). The aperture unit changes an open diameter of an aperture in accordance with a condition of a photographic subject, and the mechanical shutter unit performs an opening and closing operation of a shutter for a still photograph shooting with a same time exposure. Drive control of the aperture unit and the mechanical shutter unit of the incident light flux controller 30b is performed by the optical system drive part (motor driver) 22. Since a known structure is also adopted in this structure, detailed explanation is omitted.

The imaging part 31 has a CMOS (Complementary Metal-Oxide Semiconductor) sensor (sensor part) 32 as an image sensor, a drive part 33 of the CMOS sensor 32, and an image signal output part 34. The CMOS sensor 32 converts incident light via the imaging lens 30a and the incident light flux controller (aperture and mechanical shutter units) 30b of the main imaging optical system to an image of a photographic subject and forms the image of the photographic subject on a light-receiving surface. The image signal output part 34 performs digital processing on an output from the CMOS sensor 32, and outputs it.

On the CMOS sensor 32, a number of light-receiving elements are two-dimensionally arranged in a matrix array. An optical image of a photographic subject is formed on the CMOS sensor 32, and in accordance with an amount of light of the optical image of the photographic subject, an electrical charge is accumulated on each light-receiving element. The electrical charge accumulated on each light-receiving element of the CMOS sensor 32 is outputted to the image signal output part 34. An RGB primary color filter (hereinafter, referred to as “RGB filter”) is arranged on the light-receiving elements of the CMOS sensor 32 per pixel, and an electric signal (digital RGB image signal) corresponding to three primary colors of RGB is outputted. A known structure is adopted in this structure.

The image signal output part 34 has a CDS/PGA 35, and an ADC (A/D convertor) 36. The CDS/PGA 35 performs correlated double sampling on the image signal outputted from the CMOS sensor 32, and performs gain control. The ADC 36 performs A/D conversion (analog/digital conversion) on an output from the CDS/PGA 35 and outputs it. A digital color image signal from the ADC 36 is inputted to the signal-processing part 20a of the system controller 20.

### [System Controller 20]

As described above, the system controller 20 has the signal-processing part 20a (dividing and amplifying function part) that has a dividing and amplifying function, and the calculation control circuit (CPU, that is, main controller) 20b that has a flash emission influence degree determination function.

(Signal-Processing Part 20a)

The signal-processing part 20a has a CMOS interface (hereinafter, referred to as “CMOS I/F”) 40, a memory controller 41, a YUV convertor 42, a resize processor 43, a display output controller 44, a data compression processor 45, and a media interface (hereinafter, referred to as “media I/F”) 46. The CMOS I/F 40 loads RAW-RGB data outputted from the CMOS sensor 32 via the image signal output part 34. The memory controller 41 controls the memory (SDRAM) 25. The YUV convertor 42 converts the loaded RAW-RGB data to image data in a YUV format that is displayable and storable. The resize processor 43 changes the size of an image in accordance with the size of image data that is displayed and stored. The display output controller 44 controls a display output of image data. The data compression processor 45 compresses image data in JPEG format, or the like. The media I/F 46 writes image data on a memory card, or reads out the image data written on the memory card. The signal-processing part 20a has a dividing and amplifying function part 47. The dividing and amplifying function part 47 divides an imaged image by the loaded RAW-RGB data into a plurality of blocks in order to perform signal processing such as gain processing or the like, and performs signal processing per block.

(Calculation Control Circuit 20b)

The calculation control circuit 20b performs overall system control of the digital camera 1 based on a control program stored in a ROM 20c based on operation information inputted from the operating part 21.

The calculation control circuit 20b has a distance calculator 48 that calculates a distance to a photographic subject, and a flash emission influence degree determination function part 49.

### (Memory 25)

In the memory (SDRAM) 25, the loaded RAW-RGB data in the CMOS I/F 40 is stored, and the YUV data (image data in a YUV format) converted in the YUV convertor 42 is stored, and additionally, image data in the JPEG format compressed by the data compression processor 45, or the like is stored.

YUV of the YUV data is a color system expressed by brightness data (Y), and information of color differences (a difference (U) between brightness data and blue color data (B), and a difference (V) between brightness data and red color data (R)).

### [Operation]

Next, a monitoring operation and a still image-shooting operation of the above-described digital camera 1 will be explained.

### 1) Basic Imaging Operation

In a still image-shooting mode, the digital camera 1 performs a still image-shooting operation along with performing a monitoring operation described below.

Firstly, the digital camera 1 starts operation in a recording mode, by turning the power button 3 on, and setting the shooting/playback switch dial 4 in a shooting mode by a user. When the power button 3 is turned on, and a controller detects that the shooting/playback switch dial 4 is set in the shooing mode, the controller, that is, the calculation control circuit 20b outputs a control signal to the motor driver 22, and moves the lens barrel unit 5 to a photographable position, and starts the CMOS sensor 32, the signal-processing part 20a, the memory (SDRAM) 25, the ROM 20c, the LCD (display part) 9, and the like.

By aiming the imaging lens 30a of the main imaging optical system 30 of the lens barrel unit 5 toward a photographic subject, light from a photographic subject is incident through the main imaging optical system (imaging lens system) 30, and an image of the photographic subject is imaged on a light-receiving surface of each pixel of the CMOS sensor 32. And an electric signal (analog RGB image signal) corresponding to the image of the photographic subject outputted from light-receiving elements of the CMOS sensor 32 is inputted to the ADC 36 via the CDS/PGA 35, and is converted to 12-bit RAW-RGB data by the ADC 36.

Imaged image data of the RAW-RGB data is loaded in the CMOS interface 40 of the signal-processing part 20a, and is the stored in the memory (SDRAM) via the memory controller 41.

The signal-processing part (dividing and amplifying function part) 20a has a dividing and amplifying function such that after necessary image processing in which, for example, the imaged image of the RAW-RGB data read from the memory (SDRAM) 25 is divided into a plurality of blocks, and gain (digital gain) for amplification is applied to each divided block, which is later described, is performed and the YUV convertor converts to YUV data (YUV signal), which is in a displayable format, the YUV data is stored in the memory (SDRAM) 25 via the memory controller 41.

The YUV data read from the memory (SDRAM) 25 via the memory controller 41 is sent to the LCD 9, and a live-view image (moving image) is displayed. When performing the monitoring operation, that is, when the live-view image is displayed on the LCD 9, one frame is read out at 1/30 seconds by decimation processing of the number of pixels by the CMOS interface 40.

While performing the monitoring operation, only the live-view image is displayed on the LCD 9, which functions as an electronic viewfinder, and the shutter release button 2 is in a state where it has not been pressed (including half-pressed) yet.

By display of the live-view image on the LCD 9, it is possible for the user to confirm the live-view image. It is also possible to output a TV video signal from the display output controller, and display the live-view image (moving image) on an external TV via a video cable.

The CMOS interface 40 of the signal-processing part 20a calculates an AF (autofocus) evaluation value, an AE (automatic exposure) evaluation value, and an AWB (automatic white balance) evaluation value from the loaded RAW-RGB data.

The AF evaluation value is calculated as an output integrated value of a high-frequency component-extracting filter, or an integrated value of a difference in brightness of adjacent pixels. When the digital camera is in an in-focus state, an edge portion of a photographic subject is clear, and therefore, a high-frequency component is highest. By use of the AF evaluation value, when performing an AF operation (in-focus position detecting operation), an AF evaluation value at each position of the focus lens in the imaging lens system is obtained, and a position where the AF evaluation value is largest is taken as a position where the in-focus position is detected, and the AF operation is performed.

The AE evaluation value and the AWB evaluation value are calculated from each integrated value of each of RGB colors in the RAW-RGB data. For example, an image plane corresponding to a light-receiving surface of entire pixels of the CMOS sensor 32 is equally divided into 256 areas (horizontally divided into 16 areas, and vertically divided into 16 areas), and an integrated value of each of the RGB colors of each area is calculated.

The calculation control circuit 20b as the controller reads out the calculated integrated values of each of the RGB colors, and in an AE operation, brightness of each area of the image plane is calculated, and an appropriate exposure amount is determined from a brightness distribution. Based on the determined exposure amount, exposure conditions (the number of releases of the electronic shutter of the CMOS sensor 32, an aperture value of the aperture unit, and the like) are set. Additionally, in an AWB operation, an AWB control value is determined in accordance with a color of a light source of the photographic subject. By the AWB operation, white balance is adjusted when performing conversion processing on the YUV data by the YUV convertor. The above AE operation and AWE operation are consecutively performed while performing the monitoring operation.

While performing the above monitoring operation, when the still image-shooting operation is started, that is, when the shutter release button 2 is pressed (from half-pressed to fully-pressed), the AF operation as the in-focus position detecting operation and a still image recording operation are performed.

That is, when the shutter release button 2 is pressed (from half-pressed to fully-pressed), the focus lens of the imaging lens system is moved by a drive command to the motor driver 22 from the calculation control circuit (controller) 20b, for example, a contrast evaluation type AF operation (contrast AF), a so-called hill climb AF operation, in which the lens is moved to a direction where the AF evaluation value increases, and a position where the AF evaluation value is maximum is taken as an in-focus position, is performed.

In a case where an AF (in-focus) range is an entire region from infinity to a closest distance, the focus lens (not illustrated) of the main imaging optical system (imaging lens system) 30 is moved to each focus position from the closest distance to the infinity, or from the infinity to the closest distance, and the controller reads out an AF evaluation value at each position calculated by the CMOS interface 40. A position where the AF evaluation value is largest is taken as an in-focus position, and the focus lens is moved to the in-focus position, and then the digital camera is in the in-focus state.

Then, the above AE operation is performed, when exposure is completed, a shutter unit (not illustrated) as the mechanical shutter unit of the incident light flux controller 30b is closed by a drive command from the controller to the motor driver 22, and an analog RGB image signal for a still image from the light-receiving elements (many pixels in a matrix array) of the CMOS sensor 32 is outputted. As in the case of performing the monitoring operation, the analog RGB image signal is converted to RAW-RGB data by the ADC 36.

The RAW-RGB data is loaded to the CMOS interface 40 of the signal-processing part 20b, converted to YUV data in the YUV convertor 42, and then the YUV data is stored in the memory (SDRAM) 25 via the memory controller 41. The YUV data is read out from the memory (SDRAM) 25, converted to the size corresponding to the number of recording pixels in the resize processor 43, and compressed to image data in JPEG format or the like in the data compression processor 45. After the compressed image data in JPEG format is written back in the memory (SDRAM) 25, it is read out from the memory (SDRAM) 25 via the memory controller 41, and stored in the memory card 14 via the media I/F 46.

### II. Control of Gain (Digital Gain) Applied to Each Block

(ii-1) Gain Setting Method

In the above shooting, in a case where shooting is performed with only natural light and a main photographic subject is underexposed, flash shooting, in which supplemental light is emitted in order to supplement an exposure amount, is often performed. When such underexposure due to shooting with only natural light is a condition of performing flash emission, imaging processing to obtain an image with appropriate brightness by performing the flash emission will be explained below.

Setting Gain to Center Pixel in Divided Block

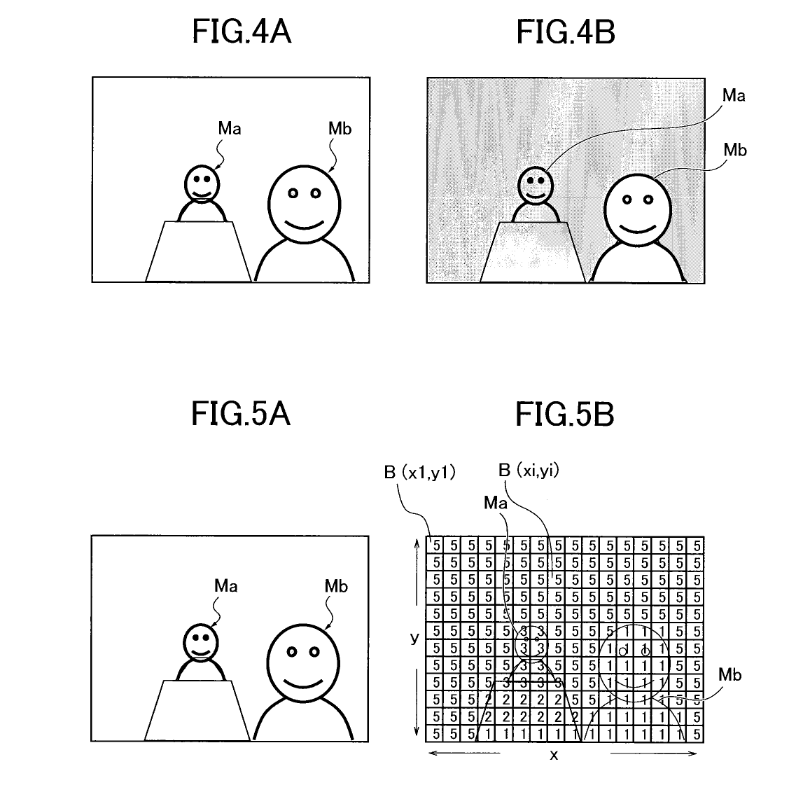

FIG. 4A illustrates an imaged image with appropriate brightness. FIG. 4B is an explanatory diagram of an imaged image obtained in a case of imaging under the condition of performing the flash emission, where a plurality of photographic subjects at different distances from flash are imaged with the flash having a fixed amount of light, and no gain processing is performed. In FIG. 4B, an image of a photographic subject darkens, as a photographic subject is at a longer distance.

FIG. 5A is an explanatory diagram of an imaged image. FIG. 5B is an explanatory diagram that illustrates an example in order to obtain the imaged image illustrated in FIG. 5A, in which an imaged image is divided into a plurality of grid-like blocks, and a gain value is set to each block.

Specifically, in order to obtain the imaged image illustrated in FIG. 5A, an imaged image is divided into a plurality of grid-like blocks, a gain value is set to each of the divided blocks, and based on the set gain value, gain processing is performed on an imaged image obtained by flash shooting.

In a case of the gain processing, basically, the dividing and amplifying function part 47 of the signal-processing part 20a divides an imaged image into a plurality of grid-like blocks, brightness of a center pixel in each of the blocks is calculated, and from the calculated brightness of the center pixel, a gain value of the center pixel is set.

Setting Gain to Target Pixel other than Center Pixel in Divided Block

In a case of calculating a gain value of a target pixel other than the center pixel in each of the blocks, the dividing and amplifying function part 47 of the signal-processing part 20a calculates the gain value of the target pixel from gain values of center pixels in adjacent blocks by linear interpolation.

In this case, the dividing and amplifying function part 47 of the signal-processing part 20a divides a block including a target pixel into four quadrants centering on a center pixel of the block, detects one of the four quadrants of the block including the target pixel, selects three adjacent blocks used for linear interpolation other than the block including the target pixel based on the detected result, and from center pixels of the selected blocks and the center pixel of the block including the target pixel, calculates a gain value of the target value by linear interpolation.

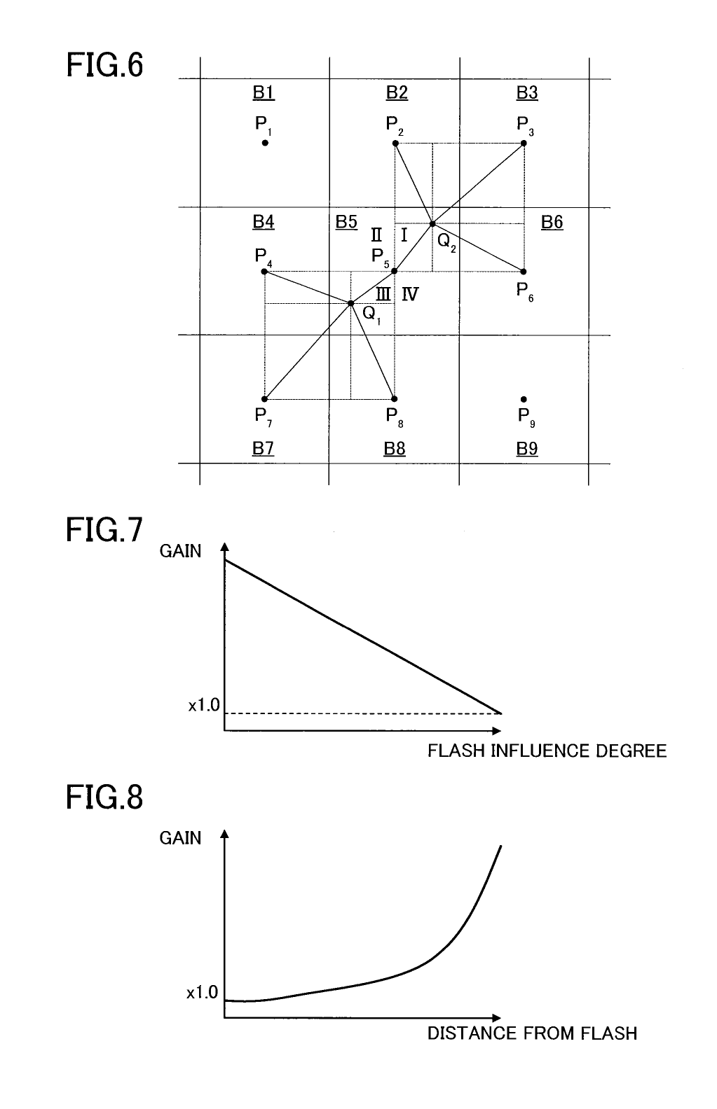

For example, in FIG. 6, reference sign B5 denotes a block including a target pixel. The block B5 is divided into four quadrants I, II, III, and IV centering on a center pixel P5 in the block B5, one of the four quadrants I, II, III, and IV of the block B5 including the target pixel is detected, and based on the detected result, three adjacent blocks used for linear interpolation other than the block B5 including target pixel is selected. A gain value of the target pixel is calculated from the block B5 including the center pixel P5 and center pixels of the three selected blocks by linear interpolation.

Reference signs P1 to P9 denote center pixels of blocks B1 to B9, respectively. When reference sign P5 is a center pixel in a target block B5, look at target pixels Q1 and Q2 in the target block B5.

Since the target pixel Q1 is located in the quadrant III of the block B5, blocks B4, B7, and B8 are selected as other blocks adjacent to the target pixel Q1. Therefore, in a case of the target pixel Q1, a center pixel of the block B5 including the target pixel Q1 and center pixels of the selected blocks B4, B7, and B8 are denoted by reference signs P5, P4, P7, and P8. A final gain for brightness correction of the target pixel Q1 is obtained by calculating final gains for brightness correction of the center pixels P4, P5, P7, P8, respectively, and calculating a weighted average of the final gains for brightness correction of the center pixels P4, P5, P7, P8 in consideration of each distance between the center pixels P4, P5, P7, P8 and the target pixel Q1.

Likewise, the target pixel Q2 is located in the quadrant I of the block B5, blocks B2, B3, and B6 are selected as other blocks adjacent to the target pixel Q2. Therefore, in a case of the target pixel Q2, a center pixel of the block B5 including the target pixel Q2 and center pixels of the selected blocks B2, B3, and B6 are denoted by reference signs P5, P2, P3, and P6. A final gain for brightness correction of the target pixel Q2 is obtained by calculating final gains for brightness correction of the center pixels P2, P3, P5, P6, respectively, and calculating a weighted average of the final gains for brightness correction of the center pixels P2, P3, P5, P6 in consideration of each distance between the center pixels P2, P3, P5, P6 and the target pixel Q2.

(ii-2) Control of Gain (Digital Gain) Setting Based on Degree of Influence of Flash (Flash Influence Degree)

In a case of performing flash shooting, by use of the above gain setting method described in (ii-1), gain is set based on a degree of influence of flash (flash influence degree) illustrated in FIG. 7, and gain processing is performed on an imaged image obtained by the flash shooting, and therefore, it is possible to obtain an image with appropriate brightness illustrated in FIG. 5A.

FIG. 8 is a gain characteristic line that illustrates a relationship between a distance from flash and gain. As is clear from FIG. 8, gain tends to be large, as the distance from the flash becomes longer.

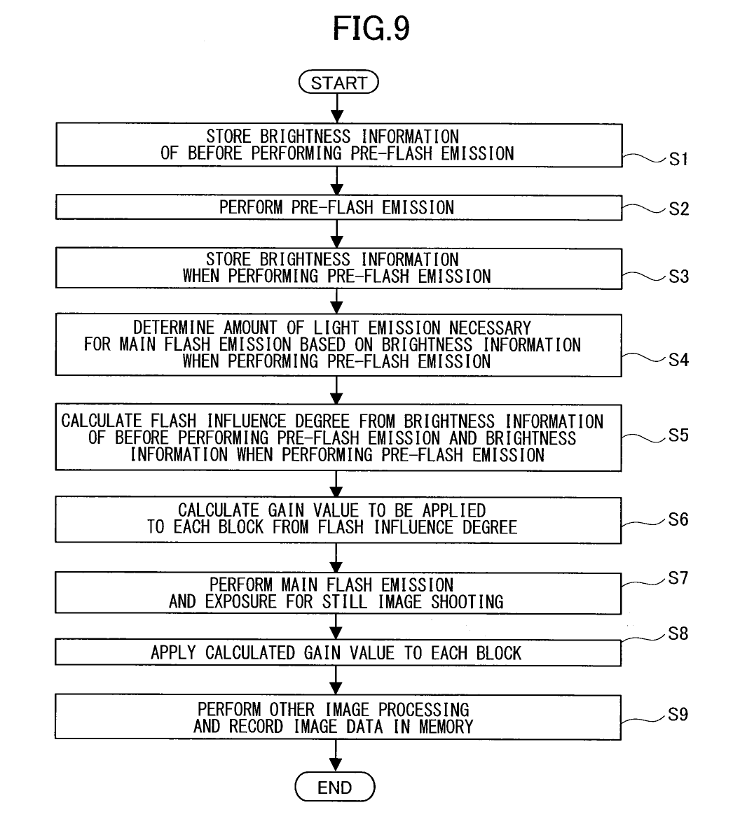

Based on FIGS. 7 and 8, and a flow diagram illustrated in FIG. 9, determination of a flash influence degree by the flash emission influence degree determination function part 49 of the calculation control circuit (CPU) 20b, and gain setting based on the flash influence degree will be explained.

In a case where an amount of light of an image obtained from pixels arranged in a matrix manner of the CMOS sensor 32 is low, and an appropriate imaged image is not obtained, flash emission is needed to be performed by the flash emission influence degree determination function part 49 of the calculation control circuit (CPU) 20b. In such a flash emission condition, when a shooting operation is performed by a user, the flash emission influence degree determination function part 49 of the calculation control circuit (CPU) 20b performs a pre-flash emission firstly, and calculates an amount of light of a main flash emission.

In a case of the above flash emission condition, when receiving a command of the shooting operation, the flash emission influence degree determination function part 49 of the calculation control circuit (CPU) 20b calculates brightness information of a photographic subject before performing the pre-flash emission of the flash 23 from an imaged image (image data) obtained by the pixels arranged in the matrix manner of the CMOS sensor 32, and stores it in the memory (SDRAM) 25 (step S1).

The above brightness information is a value in which an imaged image is divided into blocks in a grid-like manner, and Y values (brightness values) in each block are averaged per block.

Then, the flash emission influence degree determination function part 49 of the calculation control circuit (CPU) 20b determines amounts of light emission and exposure control for the pre-flash emission, and performs the pre-flash emission of the flash 23 (step S2).

Likewise, before performing the pre-flash emission of the flash 23, when performing the pre-flash emission of the flash 23, the flash emission influence degree determination function part 49 of the calculation control circuit (CPU) 20b calculates brightness information of a photographic subject performed by the pre-flash emission of the flash 23 from an imaged image (image data) obtained from the pixels arranged in the matrix manner of the CMOS sensor 32, and stores it in the memory (SDRAM) as brightness information when performing the pre-flash emission (step S3).

Then, the calculation control circuit (CPU) 20b determines an amount of light emission necessary for the main flash emission based on the brightness information when performing the pre-flash emission (step S4).

Next, the flash emission influence degree determination function part 49 of the calculation control circuit (CPU) 20b calculates a degree of influence of flash (flash influence degree) from the brightness information of before performing the pre-flash emission and the brightness information when performing the pre-flash emission (step S5).

The flash influence degree is obtained per block from a difference between the brightness information when performing the pre-flash emission and the brightness information of before performing the pre-flash emission, and as the difference between such brightness information becomes larger, the flash influence degree becomes higher.

After calculating the flash influence degree, the flash emission influence degree determination function part 49 of the calculation control circuit (CPU) 20b calculates a gain value to be applied to each block (step S6). Here, as illustrated in FIG. 7, the gain value to be applied is set such that it is small, as the flash influence degree becomes higher, and it is large, as the flash influence degree becomes lower. For example, in a case of an imaged image as illustrated in FIG. 5A, as illustrated in FIG. 5B, the imaged image is divided into a plurality of grid-like blocks, and a gain value is set per each divided block.

The gain value is set by use of the above gain setting method described in (ii-1). For example, in a range where there are a plurality of face images as a plurality of photographic subjects, gain of a target pixel is set, and in a range other than the above range, gain setting in which gain of a center pixel is set, or the like is performed. This gain setting is performed by the calculation control circuit 20b.

Each numerical value written in each block illustrated in FIG. 5B denotes the magnitude of gain. As the flash influence degree becomes lower, that is, as the distance from the flash becomes longer, gain increases. In a block corresponding to a person at a close distance, the magnitude of gain is 1, and as described above, as the distance becomes longer, gain increases, and in a block corresponding to a wall in a long distance, the magnitude of gain is 5.

In FIGS. 5A and 5B, the divided blocks are illustrated as simple 16×12 blocks, which can be divided more finely.

When the gain value is obtained, the main flash emission and exposure for still image shooting are performed at the amount of light determined in the step S4 (step S7).

Gain is applied to image data in the signal-processing part 20a, and at this time, the gain value calculated in the step S6 is applied to each block (step S8).

Other image processings are performed in the signal-processing part 20a, and image data is recorded in the memory (step S9).

When flash shooting is performed with respect to photographic subjects at different distances, as illustrated in FIG. 4B, as a photographic subject is at a longer distance, flash light does not reach the photographic subject, which darkens. However, when the above processing is performed, based on the flash influence degree, appropriate gain is applied in an image, and as illustrated in FIG. 4A, an image with appropriate brightness is obtained.

### Example 2

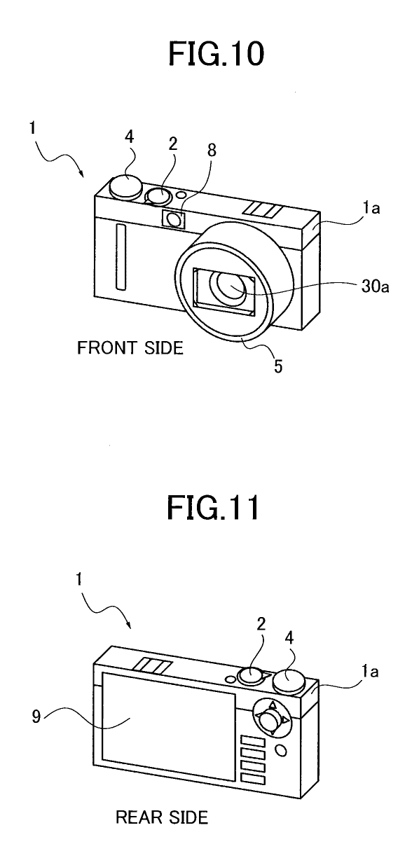

In Example 1, gain setting is not performed based on distance measurement performed by a supplemental imaging optical system for distance measurement; however, it is also possible to perform gain setting based on distance measurement. Examples of the gain setting based on the distance measurement will be explained with reference to FIGS. 10 to 18.

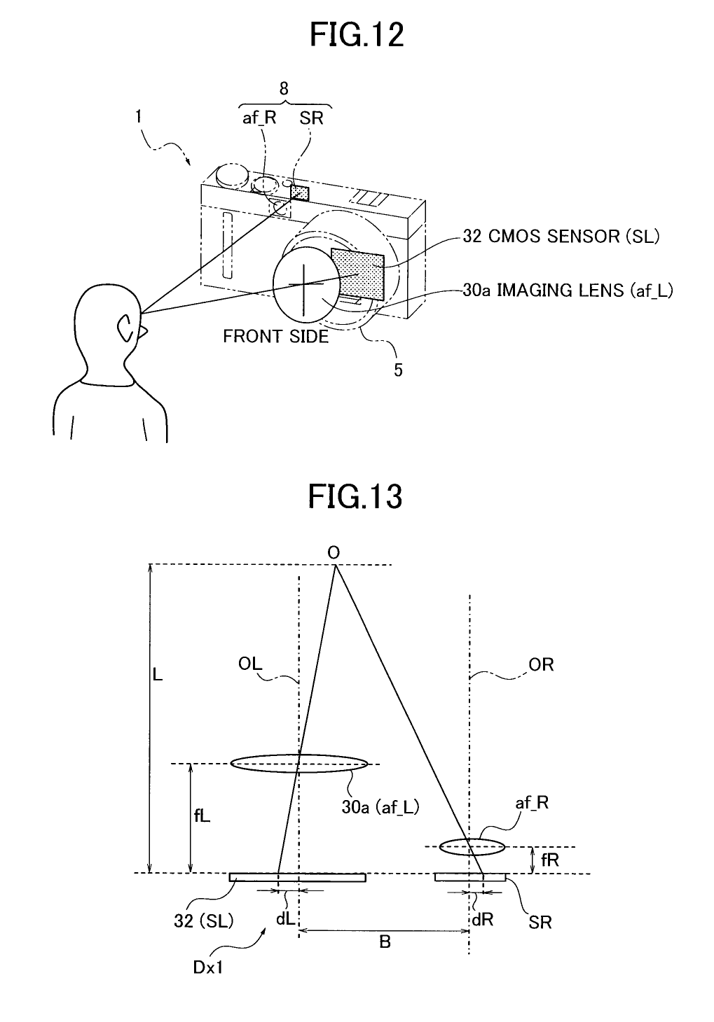

FIG. 10 is an external view of the digital camera 1, on a front side of which a supplemental imaging optical system (AF optical system) 8 is provided. FIG. 11 is an external view of a rear side of the digital camera 1 illustrated in FIG. 10. FIG. 12 is a schematic internal configuration diagram of the digital camera 1 illustrated in FIG. 10, and the supplemental imaging optical system (AF optical system) 8 includes one AF lens af_R and an image sensor SR exclusive for distance measurement. FIG. 13 is an explanatory diagram of an optical system in a case where an imaging lens 30a as a main optical system illustrated in FIG. 12 is also used as an AF lens af_L.

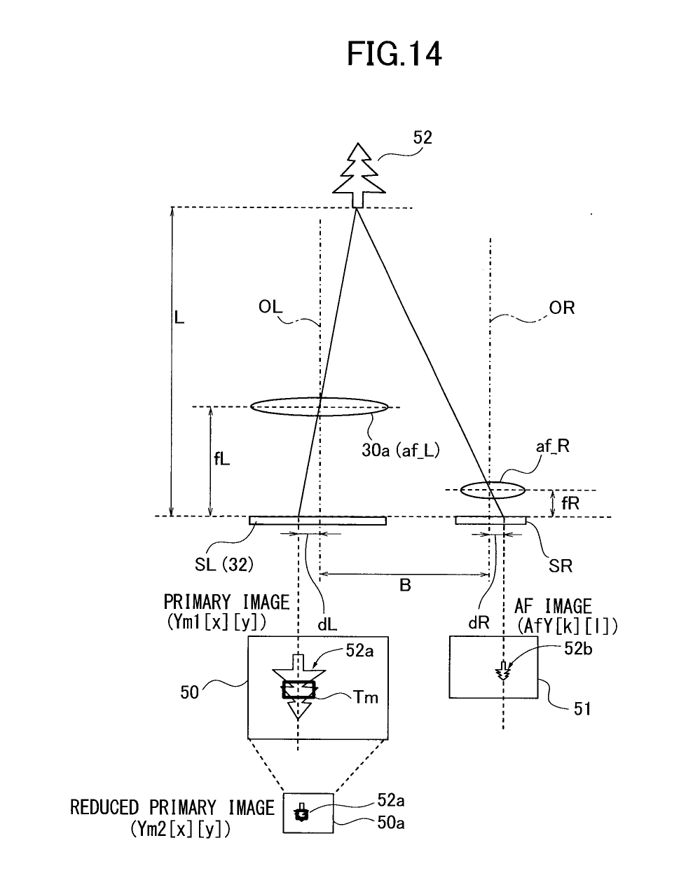

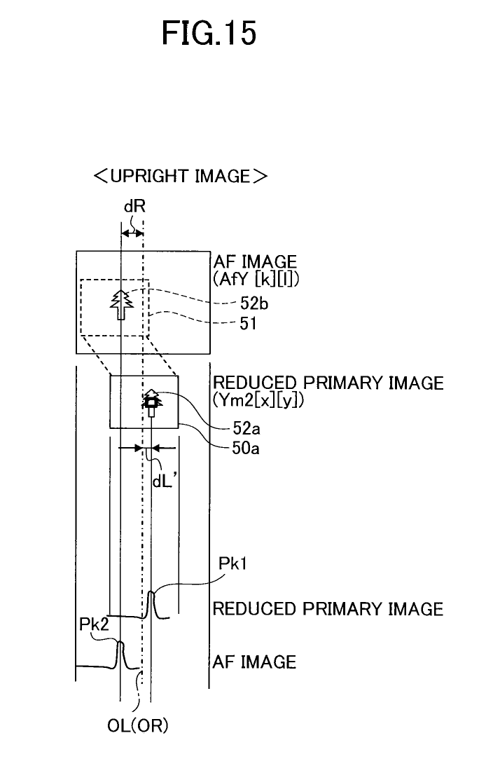

Additionally, FIG. 14 is an explanatory diagram of distance measurement performed by the imaging lens 30a as the main optical system and the AF lens af_R illustrated in FIG. 13. FIG. 15 is an explanatory diagram in a case where an output signal of a CMOS sensor 32 illustrated in FIG. 13 and an output signal of the image sensor SR (light-receiving sensor) that receives light flux from the AF lens af_R are used for distance measurement.

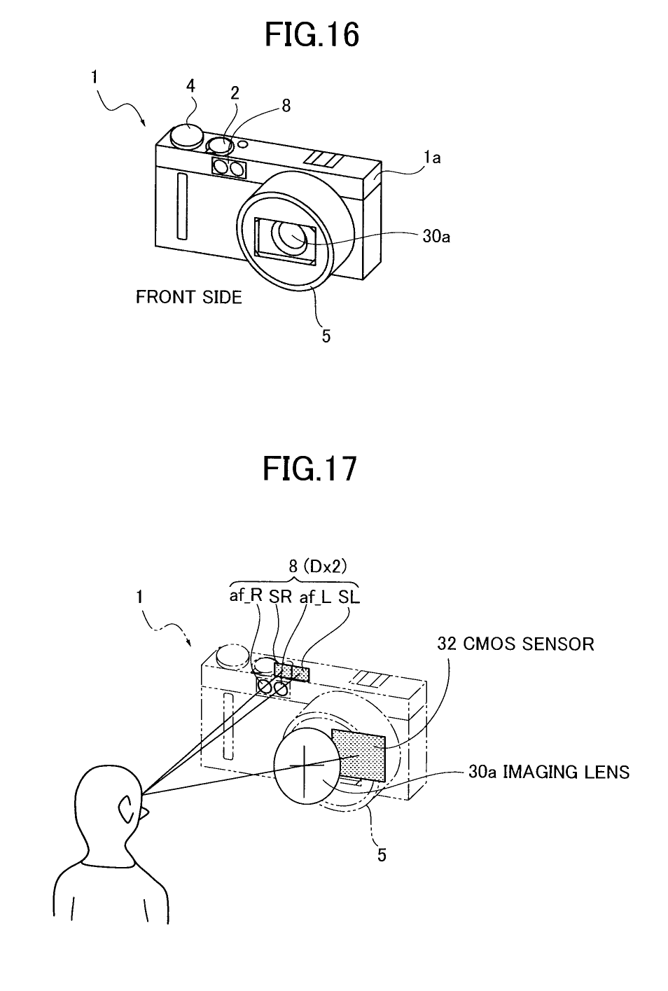

Furthermore, FIG. 16 is an external view of a front side of the digital camera 1 having two AF lenses as a supplemental imaging optical system 8 for distance measurement. FIG. 17 is a schematic internal configuration diagram of the digital camera 1 illustrated in FIG. 16. The supplemental imaging optical system (AF optical system) 8, as illustrated in FIG. 17, has two AF lenses for distance measurement (AF supplemental imaging optical system) af_L, af_R, and first and second AF image sensors for distance measurement (first and second light-receiving sensors for distance measurement) SL, SR that receive light fluxes from the two AF lenses af_L, af_R, respectively.

Incidentally, in FIG. 13, distance measurement is performed by use of an imaging lens 30a of a focal length fL, an AF lens af_R exclusive for AF of a focal length fR, a CMOS sensor 32 for shooting, and an image sensor SR for distance measurement. In a case where the imaging lens 30a and the CMOS sensor 32 illustrated in FIG. 13 are used for distance measurement, the imaging lens 30a is substantially used in the same manner as the AF lens af_L exclusive for AF illustrated in FIG. 17, and the CMOS sensor 32 illustrated in FIG. 13 is also substantially used in the same manner as the first image sensor for distance measurement SL in FIG. 17.

Comparing a case where the imaging lens 30a and the CMOS sensor 32 illustrated in FIG. 13 are used for distance measurement with a case where the AF lenses af_L, af_R exclusive for AF illustrated in FIG. 17 are used for distance measurement, a method of calculating a distance to a photographic subject is only slightly different. Firstly, distance measurement by use of the imaging lens 30a (AF lens af_L) and the CMOS sensor 32 (first image sensor for distance measurement SL) will be explained with reference to FIGS. 13 to 15.

Note that the imaging lens 30a illustrated in FIG. 13 is a main lens for imaging, and imaging magnification is different from the AF lens af_R. Therefore, in a case where explanation in which the imaging lens 30a is taken as the AF lens af_L, and the CMOS sensor 32 is taken as the first image sensor for distance measurement (distance-measuring sensor) SL is given, the imaging magnification, or the like is considered.

In FIG. 13, a structure including the imaging lens 30a, the CMOS sensor 32, the AF lens af_R, the image sensor for distance measurement SR, and the like is used as a distance-measuring device Dx1 that calculates a distance from the digital camera 1 to a photographic subject. In FIG. 17, a structure of the supplemental imaging optical system 8 including the AF lenses af_L, af_R, and the first and second image sensors for distance measurement (distance-measuring sensors) SL, SR is used as a distance-measuring device Dx2 that calculates a distance from the digital camera 1 to a photographic subject.

(1) Case where Imaging Lens 30a of Main Optical System and CMOS Sensor 32 are Used for Distance Measurement

In FIG. 13, a distance between the imaging lens 30a (AF lens af_L) and the AF lens af_R is taken as a baseline length B. The CMOS sensor 32 for shooting that receives light flux from a photographic subject O via the imaging lens 30a (AF lens af_L) is the first image sensor for distance measurement SL. The image sensor for distance measurement SR that receives light flux from a photographic subject O via the AF lens af_R is the second image sensor for distance measurement SR. The imaging lens 30a (AF lens af_L) has a focal length fL, and the AF lens af_R has a focal length fR. A ratio of the focal length fL of the imaging lens 30a (AF lens af_L) to the focal length fR of the AF lens af_R illustrated in FIG. 13 is denoted by reference sign m, and is expressed by the following Expression (a). And additionally, the focal length fL can be expressed by the following Expression (b).

m=fL/fR Expression (a)

fL=m*fR Expression (b)

A position (first image-forming position) of a light-receiving surface of the CMOS sensor 32 (first image sensor for distance measurement SL), on which the image of the photographic subject O is formed via the imaging lens 30 (AF lenses af_L), is displaced outward, along the base line, from the baseline length B by a distance dL. A position (second image-forming position) of a light-receiving surface of the image sensor for distance measurement SR (second image sensor for distance measurement SR), on which the image of the photographic subject O is formed via the AF lens af_R, is displaced outward, along the base line, from the base-line length B only by a distance dR. The baseline length B is an optical center distance between the imaging lens 30a (AF lenses af_L) and the Af lens af_R.

In other words, the first image-forming position of the image of the photographic subject O, which is a target of distance measurement, is away from a center of the CMOS sensor 32 (first image sensor for distance measurement SL) only by the distance dL, and the second image-forming position is away from a center of the image sensor for distance measurement SR (second image sensor for distance measurement SR) by the distance dR. By use of the baseline length B, and the distances dL, dR, a distance L from the CMOS sensor 32 (first image sensor for distance measurement SL) to the photographic subject O is obtained by the following expressions.

L={(B+dL+dR)*m*fR}/(dL+m*dR) Expression 1

In a case where distance measurement is performed by use of an AF optical system having AF lenses (AF lenses af_L, af_R) different from the main lens and exclusive for distance measurement in which the focal lengths fL, fR are equal, Expression 1 is expressed by the following Expression 2.

L={(B+dL+dR)*f}/(dL+dR) Expression 2

In Expression 1, focal lengths of left and right lenses can be different. As illustrated in FIG. 13, the imaging lens 30a as the main lens for shooting can be also used for distance measurement as the AF lens af_L.

By measuring the distance dL and the distance dR relative to the baseline length B, the distance L is obtained.

As illustrated in FIG. 14, a primary image 50 is obtained from the CMOS sensor 32 (first image sensor for distance measurement SL), and an AF image 51 is obtained from the image sensor for distance measurement SR (second image sensor for distance measurement SR).

For example, in a case where the photographic subject O illustrated in FIG. 13 is a standing tree 52 as illustrated in FIG. 14, on the CMOS sensor 32 (first image sensor for distance measurement SL), an image of the standing tree 52 is formed as an image of the photographic subject (image of a main photographic subject) by the imaging lens 30a (AF lens af_L), and on the image sensor for distance measurement SR (second image sensor for distance measurement SR), an image of the standing tree 52 is formed as an image of the photographic subject by the AF lens af_R. From the CMOS sensor 32 (first image sensor for distance measurement SL), a standing tree image 52a illustrated in FIG. 14 is obtained as the image of the photographic subject in the primary image 50, and from the image sensor for distance measurement SR (second image sensor for distance measurement SR), a standing tree image 52b illustrated in FIG. 14 is obtained as the image of the photographic subject in the AF image 51.

Here, the standing tree image 52a formed on the CMOS sensor 32 (first image sensor for distance measurement SL) is displayed on the LCD 9 (display part) illustrated in FIG. 11 as an upright image.

In a case of such shooting, in order to perform distance measurement of a central portion of the standing tree image 52a of the primary image 50, a user sets the standing tree image 52a to an AF target mark Tm displayed on the LCD 9 so as to correspond the central portion of the standing tree image 52a displayed on the LCD 9 as illustrated in FIG. 14 to the AF target mark Tm displayed on the LCD 9. The AF target mark Tm is displayed on the LCD 9 by image processing.

Note that the AF image is obtained without reference to an angle of view of the primary image 50. Next, in order to examine a degree of coincidence of the primary image and the AF image 51, the primary image 50 is reduced by use of the ratio m of the focal length fL to the focal length fR, that is, the focal length ratio m, and a reduced primary image 50a is made. The degree of coincidence of images is calculated by a sum of a difference in brightness array between two images as targets. The sum is called a correlation value.

In this case, a position (position of the standing tree image 52b) in the AF image 51 corresponding to a position of the standing tree image 52a in the reduced primary image 50a is obtained by a correlation value of brightness arrays of the two images. That is, the position of the standing tree image 52a in the reduced primary image 50a is specified, and in the AF image 51, the position in the AF image 51 corresponding to the position of the standing tree image 52a is obtained by a correlation value of brightness arrays of the two images.

FIG. 15 is an explanatory diagram of detection of an image of a photographic subject for AF. In FIG. 15, the standing tree images 52a, 52b formed on the CMOS sensor 32 (first image sensor for distance measurement SL) and the image sensor for distance measurement SR (second image sensor for distance measurement SR) as inverted images are inverted so as to be visibly recognized, and the optical axis OL of the imaging lens 30a (AF lens af_L) and the optical axis OR of the AF lens af_R are corresponded. By use of FIG. 15, a method of detecting an image area in the primary image 50 formed on the CMOS sensor 32 (first image sensor for distance measurement SL) in the AF image 51 formed on the image sensor for distance measurement SR (second image sensor for distance measurement SR) will be explained.

When a horizontal coordinate and a vertical coordinate of the primary image 50 are denoted by x and y, respectively, the primary image 50 can be expressed by a two-dimensional array Ym1[x][y]. By reducing a size of the primary image 50 stored in this array Ym1 by use of the focal length ratio m, a two-dimensional array Ym2[x][y] expressing the reduced primary image 50a is obtained. The reduced primary image 50a is stored in the array Ym2.

When a horizontal coordinate and a vertical coordinate of the AF image 51 are denoted by k and 1, respectively, the AF image 51 can be expressed by a two-dimensional array afY[k][1]. Each of Ym2[x][y] expressing the reduced primary image 50a and afY[k][1] expressing the AF image 51 is a brightness array. An image area in the AF image 51 corresponding to a brightness array in Ym2[x][y] corresponding to the image area in the primary image 50, that is, a position of the brightness array in afY[k][1] is detected by performing comparison and scanning of afY[k][1] and Ym2[x][y].

Specifically, by obtaining the brightness array detected in afY[k][1] in an area the size of which is the same as that in Ym2[x][y], a correlation value between the brightness array detected in afY[k][1] and the brightness array in Ym2[x][y] is obtained. This calculation of obtaining the correlation value between the brightness arrays is referred to as correlation value calculation.

The correlation value is minimized when the degree of coincidence between the images is maximized.

For example, Ym2[x][y], which is the brightness array expressing the reduced primary image 50a, has two-dimensional (2D) coordinates (x, y) and a dimension of (400, 300).

And, afY[k][1], which is the brightness array expressing the AF image 51 with 2D coordinates (k, 1) and a dimension of (900, 675).

For example, when Ym2[x][y] is located at the coordinates corresponding to a lower-right corner of afY[k][1], the correlation value is obtained by the following Expression 3.

Here, the horizontal coordinate k=a+x, and the vertical coordinate 1=β+y. “α” denotes a value that is set for horizontally moving (scanning) a range corresponding to the reduced primary image 50a in the AF image 51 (afY[k][l]), and “β” denotes a value that is set for vertically moving (scanning) a range corresponding to the reduced primary image 50a in the AF image 51 (afY[k][1]).

By use of the following Expression 3, firstly, as α=0 to 500, and β=0, and then, as α=0 to 500, and β=1, a correlation value is calculated. (When α=500, a range corresponding to the reduced primary image 50a coincides with a right end of the AF image 51.)

Correlation value=Σ(|Ym2[x][y]−afY[α+x][β+y]|) Expression 3

A correlation value is calculated as β=0 to 375. (When β=375, a range corresponding to the reduced primary image 50a coincides with a lower end of the AF image 51.)

In a case where the degree of coincidence between coordinates of Ym2[x][y] and coordinates of afY[k][l] is high, the correlation value is extremely small.

Thus, the same angle of view as that of the main image 50 is obtained in the AF image, an angle of view of which is different from the primary image 50. This operation is a correlation comparison.

As illustrated in FIG. 15, in a case where an arbitrary portion desired to measure a distance in the reduced primary image 50a is a central portion of the standing tree image 52a, a portion where contrast of the standing tree image 52a in the reduced primary image 50a becomes a peak Pk1 is calculated from an image signal of the CMOS sensor 32 (first image sensor (light-receiving sensor) for distance measurement SL), so that the standing tree image 52a is specified as an AF image. And likewise, a portion where contrast of the standing tree image 52b in the AF image 51 becomes a peak Pk2 is calculated from an image signal of the image sensor for distance measurement SR (second image sensor (light-receiving sensor) for distance measurement SR). An image-forming position, relative to the baseline length B, of the standing tree image 52a (photographic subject image) in the reduced primary image 50a is a position is away from the optical axis OL by a distance dL′. The distance dR and the distance dL′, relative to the baseline length B are calculated.

Note that in the above example, a position of a photographic subject image (AF image) in the reduced primary image 50 is obtained, a photographic subject image corresponding to the position of the photographic subject image (AF image) in the reduced primary image 50a is detected in the AF image 51, and an AF image (photographic subject image) at an arbitrary portion in the primary image 50 is specified as a portion in the AF image 51. However, coordinates where a correlation value is calculated can be thinned out.

Additionally, with respect to only a portion desired to measure a distance in the reduced primary image 50a, correlation detection is performed in the AF image 51, and a portion of a photographic subject image in the AF image 51 can be specified. Note that since the correlation value calculation is performed at a resolution of pixels, each of the distance dR, and the distance dL′ illustrated in FIG. 15 is determined in units of pixels of the AF image. Since the distance dL′ is a reduced distance, the distance dL is obtained by multiplying dL′ by the focal length ratio m.

(2) Case where Two AF Lenses Af_L, Af_R are Used for Distance Measurement

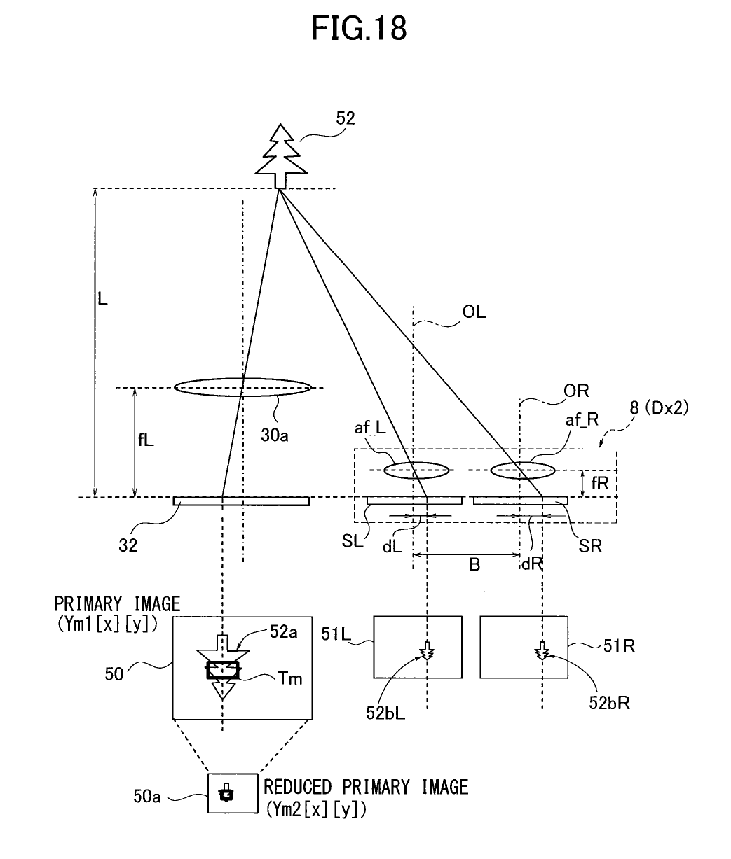

As described above, also in a case where as an AF lens af_L, the imaging lens 30a of the main optical system is not used but two AF optical systems having the same focal length are used, distance measurement is performed in the same manner as above. In a supplemental imaging optical system for distance measurement (AF optical system as distance-measuring device) illustrated in FIG. 16, as illustrated in FIG. 17, two AF lenses af_L, af_R as two AF optical systems having the same focal length are used, and as illustrated in FIG. 18, first and second image sensors for distance measurement (first and second light-receiving sensors for distance measurement) SL, SR receive light fluxes from a standing tree image (photographic subject image) 52 via the two AF lenses af_L, af_R, respectively.

In FIGS. 13 and 14, the imaging lens 30a is used as an AF lens af_L; however, in FIG. 16, in the place of the imaging lens 30a in FIGS. 13 and 14, an exclusive AF lens af_L is provided. As illustrated in FIG. 17, the supplemental imaging optical system for distance measurement 8 in FIG. 16 includes the AF lenses af_l, af_R and the first and second image sensors for distance measurement SL, SR. A relationship between the two AF lenses af_L, af_R is essentially the same as the relationship between the imaging lens 30a used as an AF lens af_L and the AF lens af_R in FIGS. 13 and 14. The relationship between the CMOS sensor 32 and the image sensor for distance measurement SR in FIGS. 13 and 14 is also essentially the same as a relationship between the first and second image sensors for distance measurement SL, SR in FIG. 16.

In a method of using two such exclusive AF lenses af_L, af_R, as illustrated in FIG. 18, firstly, from a primary image 50 obtained via the imaging lens 30a as a main optical system, a reduced primary image 50a is made by reducing by use of the focal length ratio m, and a portion desired to measure a distance in the reduced primary image 50a is obtained from each of standing tree images (photographic subject images) 52bL, 52bR in each of AF images 51L, 51R obtained via each of the AF lenses af_L, af_R by correlation value calculation, and each of distances dL, dR is calculated.

The focal depth of the AF lenses (AF supplemental imaging optical system) af_L, af_R of the supplemental imaging optical system (AF optical system) 8 is designed to be comparatively large. On the other hand, the depth of the primary image 50 is not large, and therefore, in a case where blur in the primary image 50 is large, the correlation between the standing tree 52bL in the AF image 51L and the standing tree 52bR in the AF image 51R is inaccurate, that is, there is a case where a correlation value is not small in a portion where the positions of the images are coincident with each other.

The correlation between the primary image 50 and the AF images 51L, 51R is used only for general determination of each portion desired to measure a distance in the AF images 51L, 51R. Actual distance measurement of the portion desired to measure a distance can be performed by use of the correlation between the AF images, that is, the standing tree images (photographic subject images) 52bL, 52bR obtained by the AF lenses af_L, af_R exclusive for AF, the focal depths of which are large, and the focal lengths of which are the same.

Thus, an arbitrary portion in the primary image 50 can also be determined in the AF images 51L, 51R, and by use of the positions in the AF images 51L, 51R, correlation comparison between two left and right photographic subject images (standing tree images 52bL, 52bR) of the AF optical system is performed, so that the distance at the portion can be measured.

As described above, even from an AF image having parallax with respect to a primary image, data of distance measurement accurately coincident with an absolute position of the primary image can be obtained.

In the above example, the focal length ratio between the main optical system and the AF optical system is set to m; however, the focal length ratio is not limited to m. Alternatively, a plurality of approximate values of m can be stored as scale factors of reduced image data 50a in advance, and one of the scale factors, at which a correlation value is minimized, can be selected as an actual scale factor and assigned to Expression 3. This allows more accurate distance measurement not by using a theoretical design value but by using a value that agrees with an actual image.

### Example 3

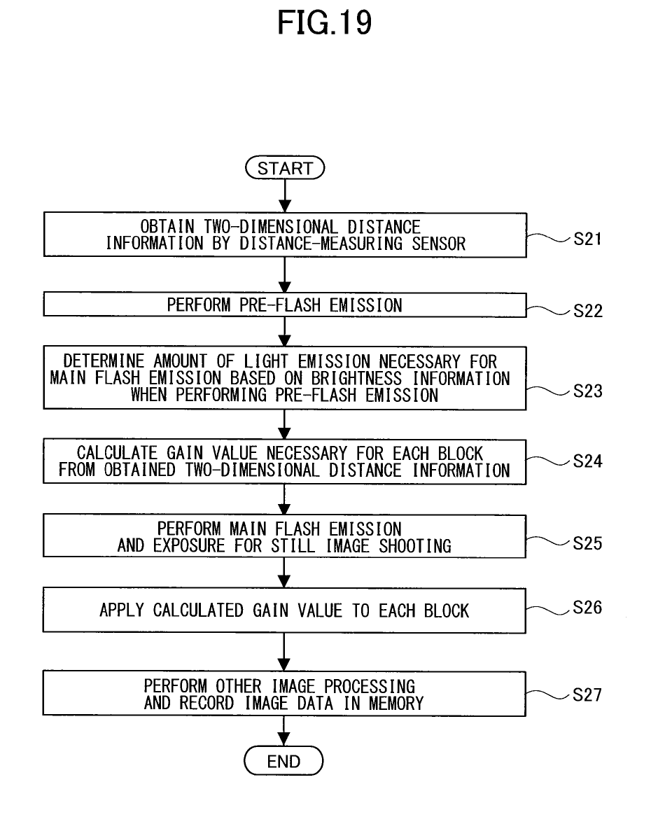

Next, gain (digital gain) setting by the calculation control circuit (CPU) 20b in FIG. 2 based on information of distance measurement and a degree of influence of flash (flash influence degree) will be explained on the basis of a flow diagram in FIG. 19.

Firstly, when a user performs a shooting operation on the digital camera 1, a distance calculation part 48 of the calculation control circuit (CPU) 20b in FIG. 2 obtains two-dimensional distance information from the digital camera 1 to a photographic subject based on outputs of the first and second image sensors for distance measurement (distance-measuring sensors) SL, SR (step S21).

And then, in a case of a flash emission condition, the distance calculation part 48 of the calculation control circuit 20b performs a pre-flash emission in the same way as the above-described step S2, and calculates a light amount of a main flash emission.

And, when receiving a command of the shooting operation, the calculation control circuit 20b calculates brightness information of before performing the pre-flash emission from an output of the CMOS sensor 32 as exposure information and stores it in the memory (SDRAM) 25. An amount of light emission and an exposure control value for the pre-flash emission are determined, and the pre-flash emission of the flash 23 is performed (step S22).

Light of the pre-flash emission is emitted toward a photographic subject and reflected thereby, and an image of the photographic subject by the reflected light from the photographic subject is formed on the CMOS sensor 32 via the imaging lens 30a. At this time, the calculation control circuit 20b obtains brightness information of the photographic subject from an output of the CMOS sensor 32. The brightness information is a value in which an imaged image is divided into grid-like blocks B (xi, yi) [i=0, 1, 2 . . . n] as illustrated in FIG. 5B, and Y values (brightness values) of a plurality of pixels in each of the blocks are averaged per block B [xi, yi] by the dividing and amplifying function part 47 of the signal-processing part 20a.

And, the calculation control circuit 20b determines an amount of light emission necessary for the main flash emission based on the brightness information when performing the pre-flash emission (step S23).

Next, the dividing and amplifying function part 47 calculates a gain value necessary for each block B (xi, yi) from the two-dimensional distance information obtained in the step S21 (step S24). At this time, the flash emission influence degree determination function part 49 of the calculation control circuit 20b calculates a difference between the brightness information when performing the pre-flash emission and the brightness information of before performing the pre-flash emission as a degree of influence of flash (flash influence degree). The flash influence degree is calculated per block B (xi, yi), and as the difference of the brightness information becomes larger, the flash influence degree becomes higher.

And, when the flash influence degree is calculated, the flash emission influence degree determination function part 49 of the calculation control circuit 20b calculates a gain value to be applied to each block B (xi, yi). Here, as illustrated in FIG. 8, the gain value to be applied is proportional to the square of the distance from the flash, and it is set such that as the distance becomes longer, the gain value increases, and as the distance becomes shorter, the gain value reduces.

When the gain value is calculated, the calculation control circuit 20b performs the main flash emission by the amount of the light emission determined in the step S23 and exposure for still image shooting of the flash 23 (step S25), and light is emitted from the flash 23 toward the photographic subject. The light reflected by the photographic subject forms an image of the photographic subject on the CMOS sensor 32 via the imaging lens 30a. The calculation control circuit 20b thus obtains image data from an output signal (image signal) of the CMOS sensor 32, and drives and controls the signal-processing part 20a, and applies a gain to the image data obtained by the signal-processing part 20a. At this time, the gain value calculated in the step S24 is applied to each block B (xi, yi) (step S26). Other image processings are performed in the signal-processing part 20a, and image data is recorded in the memory (SDRAM) 25 (step S27).

By performing the above processing, the dividing and amplifying function part 47 of the signal-processing part 20a applies appropriate gain per block in an image based on the flash influence degree calculated in the flash emission influence degree determination function part 49, and therefore, in a case of photographing a plurality of photographic subjects located at different distances, it is possible to obtain an image with appropriate brightness.

Note that as imaging apparatuses that perform a shooting method to obtain an appropriate image by flash shooting, an electronic camera device disclosed in Japanese Patent No. 3873157, and an imaging apparatus disclosed in Japanese Patent Application Publication No. 2009-094997 are known. In the electronic camera device disclosed in Japanese Patent No. 3873157, an optimal amount of light emission with respect to each of a plurality of photographic subjects is calculated, each shooting is consecutively performed with the optimal amount of the light emission, and shot images are combined. However, in order to consecutively perform shootings, a composite shift occurs, a longer time is needed for performing shooting and combining images, and a larger capacitor for the flash is needed for consecutive flash emissions, and therefore, the operation and effect according to the above embodiment of the present invention is not obtained. In the imaging apparatus disclosed in Japanese Patent Application Publication No. 2009-094997, based on a signal for imaging without a pre-flash emission and a signal for imaging with a pre-flash emission, an image is divided into a block to which flash light contributes, and a block to which the flash light does not contribute, and optimal white balance gain is applied to each. However, in such an imaging apparatus, a difference in brightness in an entire image is not considered, and an appropriate image is not always obtained. Accordingly, the operation and effect described in the above examples are not obtained.

### (Supplemental Explanation 1)

As explained above, an imaging apparatus according to an embodiment of the present invention includes an image sensor (CMOS sensor 32) that images an image of a photographic subject; a flash 23 that emits light to the photographic subject; and a controller (system controller 20) that controls the flash to emit light to the photographic subject, in a case where the image of the photographic subject in an imaged image formed on the image sensor is underexposed. Additionally, the controller (system controller 20) includes a dividing and amplifying function part 47 that divides the imaged image into a plurality of grid-like blocks, and applies digital gain per each divided block; and a flash emission influence degree determination function part 49 that determines a flash influence degree per each divided block. In a case of emitting the flash and performing shooting, a value of the digital gain applied per each divided block by the dividing and amplifying function part 47 is determined, in accordance with the flash influence degree per each divided block determined by the flash emission influence degree function part 49.

According to the above structure, by the dividing and amplifying function part 47 that applies digital gain and the flash emission influence degree determination function part 49 in a scene where a plurality of photographic subjects are located at different distances, it is possible to obtain an effect of the flash 23 evenly.

### (Supplemental Explanation 1-1)

Alternatively, an imaging apparatus according to an embodiment of the present invention includes an image sensor (CMOS sensor 32) that images an image of a photographic subject; a signal-processing part 20a that an image signal of an imaged image outputted from the image sensor (CMOS sensor 32); a flash 23 that emits light to the photographic subject; and a main controller (calculation control circuit 20b) that controls the flash to emit light to the photographic subject, in a case where the image of the photographic subject in the imaged image is underexposed. Additionally, the signal-processing part 20a includes a dividing and amplifying function part 47 that divides the imaged image into a plurality of grid-like blocks, and applies digital gain per each divided blocks. The main controller (calculation control circuit 20b) includes a flash emission influence degree determination function part 49 that determines a flash influence degree per each divided block. In a case of emitting the flash and perform shooting, the main controller (calculation control circuit 20b) determines a value of the digital gain applied per each divided block by the dividing and amplifying function part 47, in accordance with the flash influence degree per each divided block determined by the flash emission influence degree function part 49.

According to the above structure, by the dividing and amplifying function part 47 of the signal-processing part 20a that applies digital gain and the flash emission influence degree determination function part 49 of the main controller (calculation control circuit 20b), in a scene where a plurality of photographic subjects are located at different distances, it is possible to obtain an effect of the flash 23 evenly.

### (Supplemental Explanation 2)

Additionally, in an imaging apparatus according to an embodiment of the present invention, the flash emission influence degree determination function part 47 of the controller (system controller 20) determines the flash influence degree by comparing a brightness value (Y value) obtained from an imaged image when performing a pre-flash emission before performing a main flash emission with a brightness value (Y value) obtained from an imaged image of immediately before performing the pre-flash emission.

According to the above structure, in a scene where a plurality of photographic subjects are located at different distances, it is possible to obtain an effect of the flash 23 evenly.

### (Supplemental Explanation 3)

An imaging apparatus according to an embodiment of the present invention, further includes a distance calculator 48 that calculates a distance from the photographic subject per each divided block. And the flash emission influence degree determination function part 49 determines the flash influence degree in accordance with the distance from the photographic subject per each divided block calculated by the distance calculator 48.

According to the above structure, in a scene where a plurality of photographic subjects are located at different distances, it is possible to obtain an effect of the flash 23 evenly.

### (Supplemental Explanation 4)

Additionally, in an imaging apparatus according to an embodiment of the present invention, the distance calculator 48 calculates the distance from the photographic subject by use of a distance-measuring sensor (CMOS sensor (distance-measuring sensor) 32 (SL) and the image sensor for distance measurement (distance-measuring sensor) SR illustrated in FIG. 13, or first and second image sensors for distance measurement (distance-measuring sensors) SL, SR) capable of measuring a distance on a two-dimensional plane.

According to the above structure, it is possible to achieve distance calculation on the two-dimensional plane highly-accurately at high speed.

### (Supplemental Explanation 5)

Additionally, in an imaging apparatus according to an embodiment of the present invention, the distance calculator 48 performs contrast autofocus (AF), and calculates the distance from the photographic subject based on a peak position of contrast of the image of the photographic subject per each divided block.

According to the above structure, it is possible to achieve the distance calculation on the two-dimensional plane at low cost.

(Supplemental explanation 6)

Additionally in an imaging apparatus according to an embodiment of the present invention, the dividing and amplifying function part 47 of the controller (system controller 20) divides the imaged image into a plurality of blocks (B1 to B9) each having a plurality of pixels, sets digital gain as digital gain of each divided block (each of B1 to B9) to a center pixel (P1 to P9) in each divided block (each of B1 to B9), and so as not to cause the occurrence of a difference in brightness between brightness of pixels other than the center pixel (P1 to P9) in each divided block (each of B1 to B9) between adjacent pixels, determines digital gains of the pixels (for example, Q1, Q2 in block B5) other than the center pixel (P1 to P9) of each divided block (each of B1 to B9) from digital gains of center pixels (P2 to P4, P7, P8) of adjacent blocks (B1 to B4, B6 to B9) by linear interpolation.

According to the above structure, it is possible to suppress an appearance of a brightness level difference in an image due to a light amount by smoothly applying a change in gain.

Thus, even in a case where a plurality of photographic subjects are located at different distances from flash, it is possible to obtain appropriate brightness by dividing an imaging region into grid-like blocks, calculating a degree of influence of flash emission (flash influence degree), and applying a gain per block in accordance with the calculated degree of the influence of the flash emission.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An imaging apparatus comprising:
an image sensor that images an image of a photographic subject;
a flash that emits light to the photographic subject; and
a controller that controls the flash to emit light to the photographic subject, in a case where the image of the photographic subject in an imaged image formed on the image sensor is underexposed,
wherein the controller includes a dividing and amplifying function part that divides the imaged image into a plurality of grid-like blocks, and applies digital gain per each divided block; and a flash emission influence degree determination function part that determines a flash influence degree per each divided block, and in a case of emitting the flash and performing shooting, the controller determines a value of the digital gain applied per each divided block by the dividing and amplifying function part, in accordance with the flash influence degree per each divided block determined by the flash emission influence degree function part.

2. The imaging apparatus according to claim 1, wherein the flash emission influence degree determination function part determines the flash influence degree by comparing a brightness value obtained from an imaged image when performing a pre-flash emission before performing a main flash emission with a brightness value obtained from an imaged image of immediately before performing the pre-flash emission.

3. The imaging apparatus according to claim 1, further comprising:
a distance calculator that calculates a distance from the photographic subject per each divided block;
wherein the flash emission influence degree determination function part determines the flash influence degree in accordance with the distance from the photographic subject per each divided block calculated by the distance calculator.

4. The imaging apparatus according to claim 3, wherein the distance calculator calculates the distance from the photographic subject by use of a distance-measuring sensor capable of measuring a distance on a two-dimensional plane.

5. The imaging apparatus according to claim 3, wherein the distance calculator performs contrast autofocus, and calculates the distance from the photographic subject based on a peak position of contrast of the image of the photographic subject per each divided block.

6. The imaging apparatus according to claim 1, wherein the dividing and amplifying function part divides the imaged image into a plurality of blocks each having a plurality of pixels, sets digital gain as digital gain of each divided block to a center pixel in each divided block, and so as not to cause the occurrence of a difference in brightness between brightness of pixels other than the center pixel in each divided block between adjacent pixels, determines digital gains of the pixels other than the center pixel of each divided block from digital gains of center pixels of adjacent blocks by linear interpolation.
